(19) United States
(12) Patent Application Publication
(10) Pub. No.: US 2005/0226605 A1
(43) Pub. Date: Oct. 13, 2005

(54) Method and system for seamless record of real-time video and audio data

(76) Inventors: Kun Shan Wang, Kaohsiung (TW); Chien An Chen, Tainan (TW)

Correspondence Address: LOWE HAUPTMAN GILMAN & BERNER, LLP, Suite 310, 1700 Diagonal Road, Alexandria, VA, 22314, US

(21) Appl. No.: 10/821,896

(22) Filed: Apr. 12, 2004

(51) Int. Cl. H04N 5/781

(52) U.S. Cl. 386/125; 386/126

(57) ABSTRACT

A method for seamless record of real-time video and audio data, which is utilized in a disc burning system having a disc burning device and a storing device for recording a real-time video and audio data, comprises following steps: recording the real-time video and audio data to a first disc by the disc burning device; recording the continuing real-time video and audio data to the storing device after the first disc is fully recorded and saving the continuing real-time video and audio data as a plurality of multimedia files; and burning at least one multimedia file to at least one second disc. The features of the present method is that a user does not need to wait for replacing the first disc while it is fully recorded, and the user can decide when to burn the multimedia file(s) to the second disc(s) so as to reach the object of seamless record of real-time video and audio data. The present invention also provides a system for seamless record of real-time video and audio data.

### BACKGROUND OF THE INVENTION

1. Field of the Invention

This invention generally relates to a method and system for record of real-time video and audio data, and more particularly to a method and system for seamless record of real-time video and audio data.

2. Description of the Related Art

Even though the capacity of a DVD disc is about several gigabytes and far larger than that of a VCD disc, the capacity of a DVD disc is still not enough for recording long video and audio data with high quality. Therefore, if a long (several hours) video and audio data is required to be recorded within one DVD disc with high-quality format, it is impossible except for reducing the quality of the long video and audio data. Accordingly, the requirements of long recoding and high quality for a video and audio data cannot be met at the same time.

Presently, when a user intends to record a real-time video and audio data e.g., a TV program on a DVD disc with high-quality format, the capacity of the DVD disc might not be enough if the TV program is too long. Therefore, when the DVD disc is fully recorded, the user needs to replace the fully recorded DVD disc with a blank DVD disc so as to keep on recording the TV program. However, a partial section of the TV program might be unrecorded and lost during the period of replacing the DVD disc.

In order to solve the above problem, PHILIPS provides a solution by installing a memory inside a burning device. In this manner, a user can be reminded to replace the disc while it is almost fully burned, and the data to be recorded will be loaded to the memory while the user replaces the disc. Then, the data on the memory will be burned to a blank disc with a high-speed rate after the user replaces the disc so as to achieve the object of seamless record. However, in this manner, the user needs to wait for replacing the disc during the recording period, which might cause great inconvenience for users, especially for the users not on the burner site, at office, for example.

Therefore, TOSHIBA, PANASONIC, PIONEER and SHARP provide another solution in which a hard disk with dozens of gigabytes is installed within a video recorder having a DVD burning device. The objects of installing the hard disk are as following:
1. According to the “time-shifting” function, the captured video and audio data is temporarily stored on the hard disk and then compressed and burned to a disc so as to avoid delaying the burning rate by the compressing process.
2. For the video and audio data, the recording rate to a hard disk is faster than that to a disc so as to increase recording efficiency.
3. After a disc is fully burned, the continuing video and audio data is then continuously stored to the hard disk so as to avoid interrupting the recording.

When the video recorder starts the function of real-time video and audio record, a real-time video and audio data will be burned to a disc until the disc is fully burned, and then recorded to the hard disk as well as saved as a file on the hard disk if the real-time video and audio data is still going. In this manner, the user does not need to wait for replacing the disc and is able to burn this file to a blank disc while free. However, there exists a disadvantage: if the size of the file is larger than the capacity of a blank DVD disc, the file should proceed with complicated splitting and compressing processes and then burned to a plurality of DVD discs.

Accordingly, the present invention provides a method and system for seamless record of real-time video and audio data such that a user does not need to wait for replacing a disc and is able to watch the recorded video and audio data immediately after a recording task. Further, the present method and system are not limited by the capacity of a disc so as to achieve the objects of seamless record of video and audio data.

### SUMMARY OF THE INVENTION

It is an object of the present invention to provide a method and system for seamless record of real-time video and audio data such that a user does not need to wait for replacing a disc and is able to watch the recorded video and audio data immediately after a recording task.

It is another object of the present invention to provide a method and a system for seamless record of real-time video and audio data, which are not limited by the capacity of a disc so as to achieve the objects of seamless record of video and audio data.

In order to achieve the above objects, the present invention provides a method for seamless record of real-time video and audio data, which is utilized in a disc burning system having a disc burning device and a storing device for recording a real-time video and audio data. The method comprises following steps: recording the real-time video and audio data to a first disc by the burning device; recording the continuing real-time video and audio data to the storing device after the first disc is fully recorded and saving the continuing real-time video and audio data as a plurality of multimedia files; and burning at least one multimedia file to at least one second disc.

The present invention further provides a system for seamless record of real-time video and audio data, which is used for recording a real-time video and audio data. The system comprises a disc burning device and a storing device, wherein the disc burning device is used for recording the real-time video and audio data on a first disc, and the storing device is used for saving the continuing real-time video and audio data as a plurality of multimedia files after the first disc is fully recorded.

One aspect of the method and system for seamless record of real-time video and audio data according to the present invention is that a user does not need to wait for replacing a disc while it is fully recorded by a real-time video and audio data and is able to watch the recorded video and audio data immediately after a recording task finishes. Further, the user is able to decide when to burn the multimedia file(s), temporarily saved on the storing device, to the second disc(s) so as to reach the objects of seamless record of real-time video and audio data.

Another aspect of the method and system for seamless record of real-time video and audio data according to the present invention is that a user does not need to consider the capacity of a disc so as to facilitate the seamless record of a long real-time video and audio data.

### BRIEF DESCRIPTION OF THE DRAWINGS

Other objects, advantages, and novel features of the present invention will become more apparent from the following detailed description when taken in conjunction with the accompanying drawings.

FIG. 1 is a schematic view of a disc burning system for illustrating the method for seamless record of real-time video and audio data of the present invention.

FIG. 2 is a flow chart for illustrating the method for seamless record of real-time video and audio data of the present invention.

FIG. 3 is another flow chart for illustrating the method for seamless record of real-time video and audio data of the present invention.

FIG. 4 is a schematic view of a disc burning and playing system for illustrating the method for seamless record of real-time video and audio data of the present invention.

FIG. 5 is a schematic view of the file mapping table corresponding to the saved multimedia files according to the present invention.

### DETAILED DESCRIPTION OF THE PREFERRED EMBODIMENT

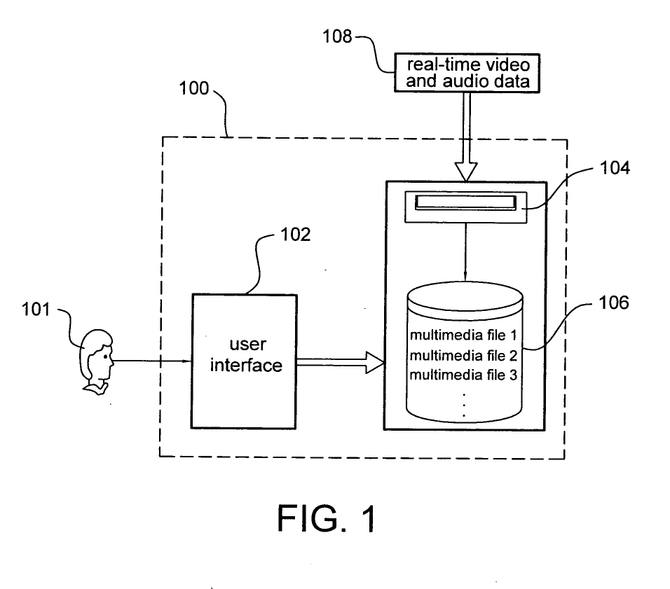

FIG. 1 is a schematic view of a disc burning system 100 for illustrating the method for seamless record of real-time video and audio data of the present invention. The disc burning system 100 includes a user interface 102, a disc burning device 104 and a hard disk device 106. When a user 101 intends to record a real-time video and audio data 108 e.g., a TV program or a broadcasting program, the user 101 needs to put a blank disc (not shown) into the disc burning device 104 and then sets the recording conditions, such as recording time, burning rate and burning mode, by the user interface 102. Finally, the burning process for the real-time video and audio data 108 begins.

In the disc burning system 100, after the disc (not shown) is fully recorded by the real-time video and audio data 108, the continuing real-time video and audio data 108 can be recorded to the hard disk device 106 immediately and saved as a plurality of multimedia files in order until the recording task for the real-time video and audio data 108 finishes. Preferably, the size of each multimedia file stored on the hard disk device 106 is smaller than or approximately equal to the capacity of a blank disc such that the user 101 can anytime burn these multimedia files to other blank discs from the hard disk device 106. In this manner, the user 101 does not need to wait for replacing the disc while it is fully recorded and consider the capacity of a disc for recording so as to easily achieve the objects of seamless record of long real-time video and audio data.

In the above embodiment, a personal computer or a VCD/DVD home video recorder can achieve the disc burning system 100. For example, a personal computer usually comprises a disc burner (disc burning device 104), a hard disk (hard disk device 106) and a user interface (user interface 102), wherein the user interface is a software interface displayed on a monitor. A VCD/DVD home video recorder usually comprises a VCD/DVD disc burning device (disc burning device 104), hard disk (hard disk device 106) and a user interface (user interface 102) wherein the user interface is a control panel including a small display panel and some control bottoms. In addition, the disc burning device 104 can be a DVD burning device or a CD burning device for recording the real-time video and audio data 108 on a DVD (e.g., DVD+R, DVD-R or DVD-RAM) disc or a CD (e.g., CD-R or CD-RW) disc or other media discs.

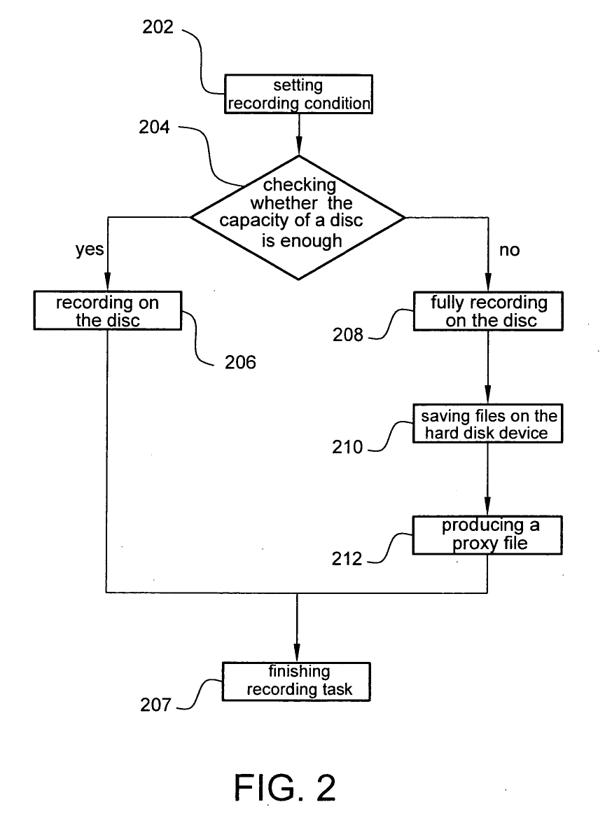

FIG. 2 is a flow chart for illustrating the method for seamless record of real-time video and audio data of the present invention. Now referring to FIGS. 1 and 2, first, the user needs to set some recording conditions, such as recording time, burning rate and burning mode, by the user interface 102 while the disc burning system 100 starts the burning (recording) process for the real-time video and audio data 108 (step 202). After setting the burning conditions, the disc burning system 100 will check whether the capacity of the blank disc is enough for recording the real-time video and audio data 108 according to the set recording time (step 204). If the capacity of the blank disk is enough for recording the real-time video and audio data 108, the real-time video and audio data 108 will be recorded to the blank disk (step 206) until the recording task finishes (step 207). In addition, if the capacity of the blank disk is not enough for recording the real-time video and audio data 108, the real-time video and audio data 108 will be recorded to the blank disc (step 208) and then continue being recorded to the hard disk device 106 as well as saved as a plurality of multimedia files after the blank disc is fully recorded (step 210), wherein the size of each multimedia file is smaller than or approximately equal to the capacity of a blank disc. Finally, a proxy file is produced and saved on the hard disk device 106 (step 212) and then the recording task finishes (step 207).

In this embodiment, the proxy file is used for recording the information of the multimedia files such as file size, file format and file location (or path). Further, the user 101 can anytime and directly burn the multimedia files to other blank discs from the hard disk device 106 since the size of each multimedia file is smaller than or approximately equal to the capacity of a blank disc.

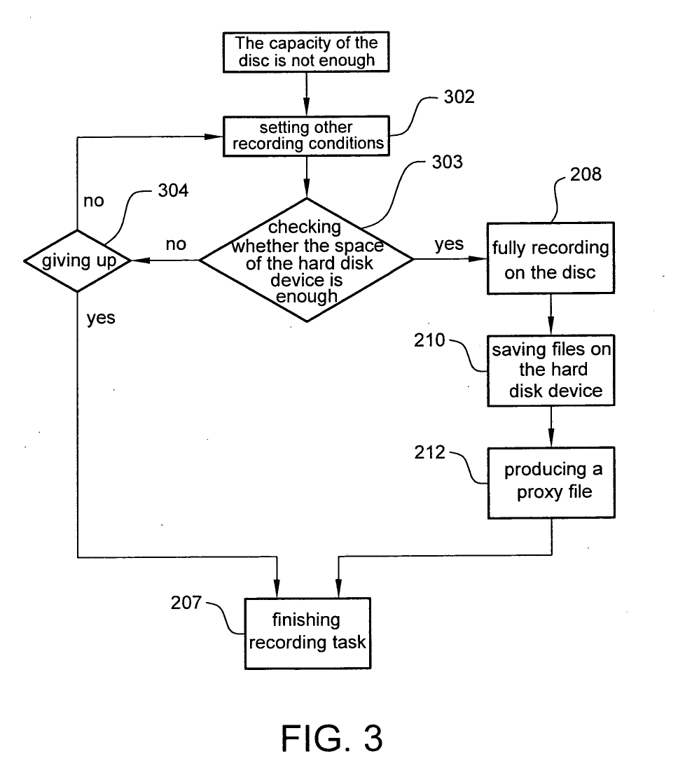

The method for seamless record of real-time video and audio data as illustrated in FIG. 2 further comprises steps (see FIG. 3) between the step 204 and the step 208 (see FIG. 2). Now referring to FIGS. 1, 2 and 3, after it is checked that the capacity of the blank disc is not enough for recording the real-time video and audio data 108 as shown in FIG. 2, the user 101 can set some other recording conditions by the user interface 102, such as the location (or path) in which the multimedia files will be saved, a multimedia file format supported by VCD, SVCD or DVD standards and compression rate (step 302); then, the number of the multimedia files to be saved and the total size of these multimedia files can be calculated according to the preset recording time in step 202 and the preset multimedia file format and compression rate in step 302, wherein the multimedia files with different file formats or compression rates will have different file sizes for a fixed recording time. The multimedia file format supported by VCD, SVCD or DVD standards can be selected from the group consisting of MPEG, AV1, MP3 and VOB (Video Object) file formats, which can be played by a personal computer or a home VCD/DVD video recorder. It should be noted that the above-mentioned file formats are to be considered in all respects as illustrative and not restrictive.

Then, the disc burning system 100 will check whether the space of the hard disk device 106 is enough for storing all these multimedia files (step 303). If the hard disk device 106 is enough for storing all these multimedia files, the steps 208, 210 and 212 will proceed subsequently and the recording task finishes (step 207). In addition, if the hard disk device 106 is not enough for storing all these multimedia files, the user 101 can select whether to give up the recording task through the user interface 102 (step 304). If the user 101 selects “yes (giving up)”, the recording task finishes (step 207). If the user 101 selects “no (not giving up)”, user 101 needs to reset the recording condition, for example, the multimedia file format and the compression rate according to the step 302 such that it is rechecked whether the space of the hard disk device 106 is enough for storing all the multimedia files (step 303).

According to another substituted embodiment of the present invention, if the hard disk device 106 is not enough for storing all these multimedia files, the number of the multimedia files or the length (recording time) which the hard disk device 106 can only store or record will shown in the user interface 102 for user's references, such that the user 101 can decide and select whether to give up the recording task through the user interface 102 (step 304). If the user 101 cannot accept the number of the multimedia files or the length, the user 101 can select “yes (giving up)” so as to finish the recording task (step 207). On the contrary, if the user 101 can accept the number of the multimedia files or the length, the user 101 can select “no (not giving up)” such that the steps 208, 210 and 212 will proceed subsequently and the recording task will finish (step 207) after the hard disk device 106 is fully stored.

One feature of the method and system for seamless record of real-time video and audio data according to the present invention is that the size of each multimedia file is smaller than or approximately equal to the capacity of a blank disc (DVD disc or CD disc) such that the multimedia files need not proceed with splitting and compressing processes and can be burned to other blank disc directly.

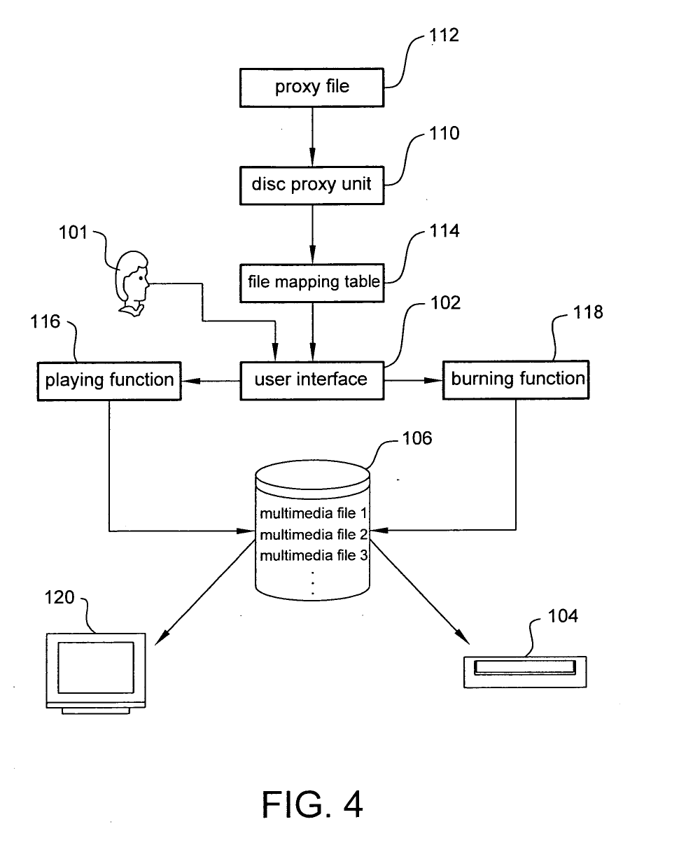

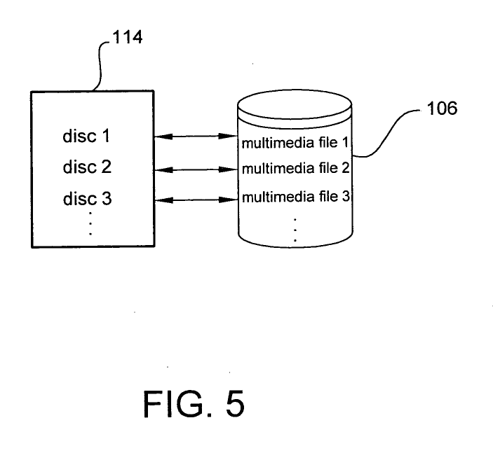

The disc burning system 100 according to the present invention further comprises a disc proxy unit 110 as shown in FIG. 4. The disc proxy unit 110 will produce a file mapping table 114 according to the information of the multimedia files recorded on a proxy file 112 (as described in step 212). The file mapping table 114 is a disc menu including numbered discs as shown in FIG. 5, which is provided on the user interface 102. Each numbered disc on the file mapping table 114 is respectively corresponding to each multimedia file on the hard disk device 106. The user 101 can select at least one numbered disc of the file mapping table 114 through the user interface 102 and then decide to start a playing task or a burning task.

For example, if the user 101 intends to play the multimedia file 1 (see FIG. 5), the user 101 can select disc 1 of the file mapping table 114 through the user interface 102 and then select a playing function 116 so as to play the multimedia file 1, which is corresponding to the selected disc 1, by a monitor 120.

In addition, if the user 101 intends to burn the multimedia file 2 to a blank disc, the user 101 can select disc 2 of the file mapping table 114 through the user interface 102 and then select a burning function 118 so as to burn the multimedia file 2, which is corresponding to the selected disc 2, to a blank disc by a disc burning device 104.

It should be noted that if the capacity of the blank disc is large enough, the user 101 could also select more than two multimedia files through the file mapping table 114 and then burn them to the same blank disc.

In another substituted embodiment of the present invention, the real-time video and audio data 108 can be directly stored to the hard disk device 106 and saved as a plurality of multimedia files in order without being recorded to the first disc in the beginning of the recording task such that the user 101 can immediately watch the recorded multimedia files or burn them to one or more blank discs. One feature of the method and system for seamless record of real-time video and audio data according to the present invention is that the real-time video and audio data 108 (see FIG. 1) will be continuously recorded to the hard disk device 106 and saved as a plurality of multimedia files in order after a first disc is fully burned such that the user 101 does not need to wait for replacing the disc. Alternatively, the real-time video and audio data 108 can be directly stored to the hard disk device 106 and saved as a plurality of multimedia files in order such that the user 101 does not need to wait for replacing the disc. Another feature of the present invention is that after the recording for the real-time video and audio data 108 finishes, the user 101 can decide to immediately watch the recorded multimedia files temporarily stored on the hard disk device 106 or to selectively burn them to at least one second disc. Preferably, the size of each multimedia file is smaller than or approximately equal to the capacity of the second disc such that the user 101 can burn the selected multimedia file(s) to the second disc directly.

Although the invention has been explained in relation to its preferred embodiment, it is not used to limit the invention. It is to be understood that many other possible modifications and variations can be made by those skilled in the art without departing from the spirit and scope of the invention as hereinafter claimed.

1. A method for seamless record of real-time video and audio data, which is utilized in a disc burning system having a disc burning device and a storing device for recording a real-time video and audio data, comprising following steps:
recording the real-time video and audio data to a first disc by the disc burning device; and
recording the continuing real-time video and audio data to the storing device after the first disc is fully recorded and saving the continuing real-time video and audio data as a plurality of multimedia files.

2. The method for seamless record of real-time video and audio data as claimed in claim 1 further comprising the step of burning at least one multimedia file to a second disc.

3. The method for seamless record of real-time video and audio data as claimed in claim 2, wherein the first disc and the second disc are selected from a group consisting of DVD and CD discs.

4. The method for seamless record of real-time video and audio data as claimed in claim 2, wherein the size of each multimedia file is smaller than or approximately equal to the capacity of the second disc.

5. The method for seamless record of real-time video and audio data as claimed in claim 1, wherein the format of the multimedia file is selected from a group consisting of VOB (Video Object), MPEG, AV1 and MP3 formats.

6. The method for seamless record of real-time video and audio data as claimed in claim 1, wherein the real-time video and audio data is selected from one of TV and broadcasting programs.

7. The method for seamless record of real-time video and audio data as claimed in claim 1 further comprising the step of setting the format of the multimedia file prior to the step of recording the real-time video and audio data to a first disc.

8. The method for seamless record of real-time video and audio data as claimed in claim 1 further comprising the step of producing a proxy file used for recording file information of each multimedia file, wherein the file information includes at least one of file size, file format and file location (path).

9. The method for seamless record of real-time video and audio data as claimed in claim 1, wherein the disc burning system is achieved by one of a personal computer and a home video recorder.

10. A system for seamless record of real-time video and audio data, which is used for recording a real-time video and audio data, comprising:
a disc burning device for recording the real-time video and audio data to a first disc; and
a storing device for saving the continuing real-time video and audio data as a plurality of multimedia files after the first disc is fully recorded.

11. The system for seamless record of real-time video and audio data as claimed in claim 10, wherein the first disc is selected from a group consisting of DVD and CD discs.

12. The system for seamless record of real-time video and audio data as claimed in claim 10, wherein the format of the multimedia file is selected from a group consisting of VOB (Video Object), MPEG, AV1 and MP3 formats.

13. The system for seamless record of real-time video and audio data as claimed in claim 10, wherein the real-time video and audio data is selected from one of TV and broadcasting programs.

14. The system for seamless record of real-time video and audio data as claimed in claim 10, wherein the storing device is a hard disk.

15. The system for seamless record of real-time video and audio data as claimed in claim 10 further comprising a proxy file for recording file information of each multimedia file, wherein the file information includes at least one of file size, file format and file location (path).

16. The system for seamless record of real-time video and audio data as claimed in claim 15 further comprising a disc proxy unit which produces a disc menu according to the file information recorded on the proxy file, wherein the disc menu includes a plurality of numbered discs and each numbered disc is corresponding to each multimedia file.

17. The system for seamless record of real-time video and audio data as claimed in claim 16 further comprising a user interface on which the disc menu is provided and a user can select at least one numbered disc through the user interface to play the multimedia file corresponding to the selected numbered disc.

18. The system for seamless record of real-time video and audio data as claimed in claim 16 further comprising a user interface on which the disc menu is provided and a user can select at least one numbered disc through the user interface to burn the multimedia file corresponding to the selected numbered disc to a second disc.

19. The system for seamless record of real-time video and audio data as claimed in claim 18, wherein the second disc is selected from a group consisting of DVD and CD discs.

20. The system for seamless record of real-time video and audio data as claimed in claim 10 being achieved by one of a personal computer and a home video recorder.
